(19) United States
(12) Patent Application Publication
(10) Pub. No.: US 2014/0282161 A1
(43) Pub. Date: Sep. 18, 2014

(54) GESTURE-BASED CONTROL SYSTEMS AND METHODS

(71) Applicant: HONDA MOTOR CO., LTD., Tokyo (JP)

(72) Inventor: Duane Matthew Cash, Mountain View, CA (US)

(73) Assignee: Honda Motor Co., Ltd., Tokyo (JP)

(21) Appl. No.: 13/799,574

(22) Filed: Mar. 13, 2013

(51) Int. Cl. G06F 3/01

(52) U.S. Cl. CPC G06F 3/017
USPC 715/769

(57) ABSTRACT

A gesture-based control system having a graphical display and a gesture sensor. One or more interactive elements are displayed on the graphical display. When the interactive element has been dragged a threshold distance, an application associated with the interactive element is controlled. Computer-implemented methods are also described herein.

### TECHNICAL FIELD

The systems and methods described below relate generally to the field of computer systems, and, more specifically, to gesture-based control systems and methods.

### BACKGROUND

Users of conventional computer systems can utilize various techniques for providing input. Example techniques for providing inputs include typing on a keyboard, using a mouse, touching a touch-based display, and by providing non-contacting gestures. Based on the input provided the user, the computer system can perform particular actions.

### SUMMARY

In accordance with one embodiment, a computer-implemented method is provided that includes displaying an interactive element on a graphical display, where the interactive element is associated with at least one application. The computer-implemented method also includes recognizing a remote selection gesture of the interactive element and recognizing a remote drag gesture. The computer-implemented method also includes displaying a dragging indicia on the graphical display responsive to recognizing the remote drag gesture. The dragging indicia has a drag length that corresponds to the remote drag gesture. The computer-implemented method also includes controlling the at least one application associated with the interactive element when the drag length exceeds a threshold distance.

In accordance with another embodiment, a gesture-based control system is provided. The gesture-based control system includes a graphical display, a camera and a controller in communication with the graphical display and the camera. The controller is configured to display an interactive element on the graphical display, where the interactive element is associated with at least one application. The controller is also configured to recognize a remote selection gesture of the interactive element and recognize a remote drag gesture. The controller is also configured to determine a drag length of the selected interactive element responsive to recognizing the remote drag gesture and when the drag length exceeds a threshold distance, control the at least one application.

In accordance with yet another embodiment, a computer-implemented method is provided. The computer-implemented method includes displaying an interactive element on a graphical display of a vehicle, where the interactive element is associated with a vehicle subsystem. The computer-implemented method also includes recognizing a remote drag gesture associated with the interactive element and displaying a dragging indicia on the graphical display responsive to recognizing the remote drag gesture. The dragging indicia has a drag length that corresponds to the remote drag gesture. The computer-implemented method also includes controlling the vehicle subsystem when the drag length exceeds a threshold distance.

### BRIEF DESCRIPTION OF THE DRAWINGS

Various embodiments will become better understood with regard to the following description, appended claims, and accompanying drawings wherein:

FIGS. 1A-1C depict a gesture progression in accordance with an example interaction in accordance with one aspect of the present disclosure;

FIG. 2 depicts two example gestures made in a gesture field and the corresponding movement of an interactive element on a graphical display in accordance with one aspect of the present disclosure;

FIG. 3 depicts a graphical display presenting an interactive element that is controllable through gesturing in accordance with one aspect of the present disclosure;

FIG. 4 depicts a graphical display presenting an interactive element in accordance with one aspect of the present disclosure;

FIG. 5 depicts a graphical display presenting an interactive element in accordance with one aspect of the present disclosure;

FIG. 6 depicts a graphical display presenting an interactive element and a dragging indicia corresponding to a gesture in accordance with one aspect of the present disclosure;

FIG. 7 depicts a graphical display presenting an interactive element and a dragging indicia corresponding to a gesture in accordance with one aspect of the present disclosure;

FIG. 8 depicts a graphical display presenting an interactive element and a dragging indicia corresponding to a gesture in accordance with one aspect of the present disclosure;

FIG. 9 depicts an example interactive element menu displaying interactive elements A, B, and C in accordance with one aspect of the present disclosure;

FIG. 10 depicts an example interactive element menu displaying an interactive element A in accordance with one aspect of the present disclosure;

FIG. 11 depicts an example block diagram of a gesture-based control system and a gesturing field in accordance with one aspect of the present disclosure;

FIGS. 12A-B depict a simplified version of an example vehicle graphical display which can be mounted in a vehicle, with FIG. 12B illustrating an enlarged portion of FIG. 12A in accordance with one aspect of the present disclosure; and

FIG. 13 depicts an example process flow utilizing a gesture-based control system in accordance with one aspect of the present disclosure.

### DETAILED DESCRIPTION

Various non-limiting embodiments of the present disclosure will now be described to provide an overall understanding of the principles of the structure, function, and use of the gesture-based control systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term software is used expansively to include not only executable code, but also data structures, data stores and computing instructions in any electronic format, firmware, and embedded software. The terms information and data are used expansively and can include a wide variety of electronic information, including but not limited to machine-executable or machine-interpretable instructions; content such as text, video data, and audio data, among others; and various codes or flags. The terms information, data, and content are sometimes used interchangeably when permitted by context.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps can be performed in the order presented but instead may be performed in a different order or in parallel.

Graphical user interfaces can be used to present information to a user in the form of icons, graphics, or other types of interactive elements. Such interactive elements are generally associated with a particular action or command. A user typically has to supply an input to a computing system that is associated with the interactive elements presented on the graphical user interface to execute the particular action or command. In some operational environments, it is desirable to allow the user to interact with the interactive elements through remote, non-contacting gesturing. This gesturing can be tracked by a camera or other suitable technology. A user can make a gesture (or can “gesture” or “gesticulate”) by changing a position of a body part (such with a hand that is waving or pointing, for example), or a user can gesticulate without changing a position of a body part (such as by making a clenched first gesture, or by holding a body part immobile for a period of time, for example). In some cases, a stylus, remote control, or other device can be held or manipulated by the user as part of the gesture. The particular gesture made by the user, which can include both a particular body part position and a particular path of travel, for example, can be used as an interactive input.

The systems and methods described herein generally provide techniques of user interaction utilizing gesturing. In particular, a user can initiate certain actions or processes based on their gesturing relative to an interactive element presented on a graphical user interface. As used herein, “interactive element” is to broadly include a wide variety of graphical tools or components, such as graphical icons, graphical menus, graphical buttons, hyperlinks, images, and any other element which can be displayed on a graphical display and associated with or otherwise linked to an action or process that is to be performed upon activation of an interactive element.

In one example embodiment, one or more interactive elements are presented on a graphical display, such as a graphical user interface. An application, or a particular action to be performed by the application, can be associated with the interactive element. In certain embodiments, gesturing by a user is monitored to determine if the user desires to activate one of the interactive elements on the graphical user interface. When certain conditions are satisfied, an application associated with an interactive element is controlled or other type of action is performed by the system. In some embodiments, to activate the interactive element, a user executes a gesture which serves to “drag” an interactive element on the graphical user interface. Once an interactive element has been dragged a predetermined distance, or at least dragged to a position that is beyond a certain distance away from a starting point, the interactive element can be considered activated, and a process or action associated with the interactive element can be initiated. Alternatively, dragging the interactive element past the certain distance can toggle the state of an associated application or process. Thus, if an application or process is executing at the time of the drag, when an interactive element associated with the application or process is activated through dragging, the process or action associated with the interactive element can be terminated.

As described in more detail below, the distance the interactive element can be dragged beyond before the interactive element is activated can be referred to as a “threshold distance.” By activating an interactive element after it has been dragged a threshold distance, spurious activations of the interactive element by unintentional gesturing by the user can be reduced. Furthermore, in some embodiments, the magnitude of the threshold distance can be based on, for example, operational environment, user preference, and so forth. Thus, operational environments which may have higher incidents of spurious activations can utilize greater threshold distances.

Many vehicles utilize one or more graphical displays to display information to the vehicle's occupants, and in some cases, receive inputs from those occupants. Such graphical displays can be positioned in numerous places throughout the vehicle compartment. For example, some vehicles utilize a graphical display in the instrument cluster to provide vehicle information, such as a speed, mileage, oil life, and so forth. Some vehicles use a graphical display to present navigational information to the vehicle occupants. Some vehicles use a graphical display to present climate control information. Some vehicles use a graphical display to present entertainment options and information. Some vehicles use a graphical display to present information to vehicle occupants, such as information received from a smart phone or computing device that is in communication with the vehicle, such as through a universal serial bus (USB) or BLUETOOTH® connection. Utilizing the systems and methods described herein, an occupant can interact with the graphical user interface through gestures in order to initiate various processes or actions, such as opening new applications, accessing or controlling menus, buttons, toggles, switches, or executing other commands.

It is to be appreciated that the systems and methods described herein are applicable across a variety of operational environments that utilize graphical user interfaces and associated systems that are controllable through gesturing. Example graphical user interfaces include, without limitation, televisions incorporating gesture-based control systems, gaming systems incorporating gesture-based control systems, personal computers (such as laptops, tablet computers, and so forth) utilizing gesture-based control systems, and vehicles incorporating gesture-based control systems. Thus, while some of the example embodiments presented herein relate to a graphical user interface positioned with the passenger compartment of a vehicle, these embodiments are merely presented for the purposes of illustration.

FIGS. 1A-1C depict a gesture progression in accordance with an example interaction in accordance with one aspect of the present disclosure. Referring first to FIG. 1A, a graphical display 100A is illustrated that is displaying an interactive element 104. As with other graphical displays described herein, the graphical display 100A can be any suitable display device capable of presenting information to a user, such as a monitor, electronic display panel, touch-screen, liquid crystal display (LCD), plasma screen, one or more light-emitting diodes (LED), or any other display type or which may comprise a reflective surface upon which the visual information is projected. Further, as is to be appreciated, the interactive element 104 depicted in FIGS. 1A-1C, and the other interactive elements illustrated in other figures are shown as simplified icons for illustrative purposes.

A user 102 can interact with the graphical display 100A through gesturing. While movement of a hand of the user 102 is illustrated in FIGS. 1A-1C to represent gesturing, any suitable motion of a user's body can be used to activate the interactive element 104, such as movement of a user's arm, head, legs, head, and so forth. FIG. 1B depicts the user 102 making a remote selection gesture, shown as an index finger extended, which selects the interactive element 104, as indicated on graphical display 100B. In the illustrated embodiment, the interactive element 104 is shown graphically transitioning from a first state (shown in FIG. 1A) to a second state (shown in FIG. 1B) to graphically depict the selection of the interactive element 104. As is to be understood, any suitable technique for conveying a selection of a particular interactive element can be used, including an aural indication, for example. Further, any suitable remote selection gesture can be utilized to select a particular interactive element on a graphical display. In some embodiments, a pointer or other indicia displayed on the graphical display (not shown) can generally correspond to and track the movement of the user 102. When the pointer is proximate to the desired interactive element, the user 102 can initiate the remote selection gesture. The remote selection gesture can be any suitable gesture that is recognizable by the system, such as executing a pre-defined body movement when the pointer is proximate to an interactive element or holding a particular gesture or pose in place for a period of time to maintain the pointer proximate to an interactive element for a corresponding period of time, for example. In some embodiments, the remote selection gesture is performed by a user holding an object or device, such as a stylus, pointer, remote control, and so forth.

Once the interactive element 104 is selected, movement of the user 102 can cause a corresponding movement of the selected interactive element 104. FIG. 1C depicts the user 102 executing a remote drag gesture by moving their hand from a first position (shown as 102A) to a second position (shown as 102B). As shown on the display screen 100C, the interactive element 104 correspondingly moves from a first position (shown as 104A) to a second position (shown as 104B). The distance the interactive element 104 is dragged, illustrated as the drag length (“D”), generally corresponds proportionally with the distance the user 104 moved there hand, referred to illustrated as the gesture distance (“G”). Furthermore, the radial direction that the interactive element 104 is dragged also corresponds to the direction of the gesture by the user 102. As described in more detail below, when the drag length “D” exceeds a threshold distance, an application associated with the interactive element 104 can be activated and controlled. As is to be appreciated, the type of application and the type of control can vary based on operational environment.

FIG. 2 illustrates two example gestures made in a gesture field and the corresponding movement of an interactive element on a graphical display 200 in accordance with one aspect of the present disclosure. The gesture field can be a two-dimensional plane or three-dimensional space in which a user's movements can be tracked by one or more gesture sensors, such as a camera. An interactive element 204 is shown in graphical display 200. A threshold indicia 210 encircles the interactive element 204 and has a radius of “TD,” which is a threshold distance. The threshold indicia 210 represents the distance the interactive element 104 is to be moved by a user to activate the interactive element 204. While the threshold indicia 210 is circular in FIG. 2, any suitable shape or configuration can be used. Moreover, for some threshold indicia, the threshold distance at a first location can be different than a threshold distance at a second location, such as oval-shaped threshold indicia.

Referring now to a first gesture 230, a hand of user 202 is shown as moving from a first position (shown as 202A) to a second position (shown as 202B). A gesture distance “G1” represents the length of the gesture, as measured by the fingertip of the user 202. The gesture distance can be dependent on the type of movement used by the system to move an interactive element. Referring to the graphical display 200, the interactive element 204 is illustrated as moving from a first position (shown as 204A) to a second position (shown as 204B) as a result of the first gesture 230. The drag length of the interactive element 204 is shown as drag length “D1.” The drag length “D1” exceeds the threshold distance “TD” so an application associated with the interactive element 204 would be controlled responsive to the first gesture 230. While the illustrated embodiment shows the drag length “D1” measured from a center point of the interactive element 204, this disclosure is not so limited. In some embodiments, for example, the entire interactive element can cross the threshold indicia prior to activation of an associated application in process. In other embodiments, when any portion of the interactive element crosses the threshold indicia the associated application or process is activated.

A user interacting with a graphical display may not necessarily drag an interactive element in a straight line. For example, the graphical display may be part of a vehicle that is operating on bumpy terrain or a user may start dragging the interactive element in a first direction and then decide to drag the interactive element in a different direction. In order to accommodate for such conditions, in some embodiments, the drag length “D1” is determined to be a distance measured radially from a first position to a second position. Thus, if a user were to “zig zag” while dragging the interactive element, the interactive element would not necessarily be deemed activated until the drag length “D1,” as measured radially from the starting point, exceeds the threshold distance “TD.” In such an example, the actual distance the interactive element was dragged on the screen would be longer than the drag length “D1.” In other embodiments, however, the drag length “D1” can be determined to be a distance measured along the path the interactive element is dragged.

Referring now to a second gesture 240, the hand of user 202 is shown as moving from a first position (shown as 222A) to a second position (shown as 222B). A gesture distance “G2” represents to length of the gesture, as measured by the fingertip of the user 202. The interactive element 204 is illustrated as moving from a first position (shown as 204A) to a second position (shown as 204C) as a result of the second gesture 240. The drag length of the interactive element 204 is shown as drag length “D2.” The drag length “D2” does not exceeds the threshold distance “TD” so in the illustrated embodiment the second gesture 240 would not control the application associated with the interactive element 204.

A user controlling an interactive element through gesturing can selectively drag the interactive element in a variety of radial directions. FIG. 3 depicts a graphical display 300 presenting an interactive element 304 that can be controllable through gesturing in accordance with one aspect of the present disclosure. A user (not shown) can utilize gesturing to drag the interactive element in a number different radial drag directions 312A-312H. The particular radial drag direction 312A-312H can be used to determine which particular action is to be performed by the system. Thus, when the interactive element 304 is dragged by a user the threshold distance, represented as threshold indicia 310, in the radial drag direction 312G, a different action can be performed as compared to when the interactive element 304 is dragged in radial drag direction 312C. The particular number of different actions that are dependent on radial drag direction can vary. For example, in some embodiments, each radial drag direction 312A-312H can each be associated with a different action. In other embodiments, a first action can be associated with radial drag directions 312A-312D and a second action can be associated with radial drag directions 312E-312H. In some embodiments, a first action is associated with radial drag directions 312B, 312A, and 312G, a second action is associated with radial drag directions 312D, 312E, and 312F, and no action is associated with radial drag directions 312C and 312G. Furthermore, while the threshold distance shown in FIG. 3 is uniform, in some embodiments the threshold distance may vary based on radial drag direction.

Visual indicia representing a threshold distance can be presented using a variety of techniques. Referring to FIG. 4, a graphical display 400A is shown presenting an interactive element 404 in accordance with one aspect of the present disclosure. Upon selection of the interactive element 404, as shown by graphical display 400B, a threshold indicia 410 can be displayed to provide the user a visual marker representing how far the interactive element 404 should be dragged in order to activate the interactive element 404. The threshold indicia 410 can be removed from the graphical display 400B subsequent to a dragging movement, after a predetermined time period as expired, or when a user selects a different interactive element, for example. FIG. 5, by comparison, illustrates that in some embodiments a threshold indicia 510 is displayed prior to selection. A graphical display 500A is shown presenting an interactive element 504 and a threshold indicia 510. The selection of the interactive element 504, shown by the graphical display 500B does not affect the display of the threshold indicia 510. In some embodiments, however, the threshold indicia 510 presented by the graphical display 500A compared to the graphical display 500B can vary in intensity or other type of formatting.

As a user controls an interactive element through gesturing, in some embodiment a graphical display can graphically convey the dragging movement using a dragging indicia. The particular technique used for conveying a dragging indicia utilized can vary, as generally represented by the graphical displays shown in FIGS. 6-8. FIG. 6 illustrates a graphical display 600A presenting an interactive element 604 in accordance with one aspect of the present disclosure. Responsive to remote gesturing of a user (not shown), graphical display 600B displays a dragging indicia 650 that is representative of the user's remote drag gesture. In FIG. 6, the dragging indicia 650 is graphically shown as a duplicative interactive element. FIG. 7 illustrates a graphical display 700A presenting an interactive element 704 in accordance with one aspect of the present disclosure. Responsive to remote gesturing of a user (not shown), graphical display 700B displays a dragging indicia 750 representative of the user's remote drag gesture. In FIG. 7, the dragging indicia 750 is graphically shown as a translation of the interactive element 704. FIG. 8 illustrates a graphical display 800A presenting an interactive element 804 in accordance with one aspect of the present disclosure. Responsive to remote gesturing of a user (not shown), graphical display 800B displays a dragging indicia 850 that represents the user's remote drag gesture. In FIG. 8, the dragging indicia 850 is shown as a graphical line segment that generally tracks the user's remote drag gesture. In some embodiments, a user can select or otherwise determine a type of dragging indicia to be used by the system. Irrespective of the format in which the dragging indicia is displayed, the dragging indicia can be used as graphical feedback to inform a user as to how far the interactive element has been dragged in view of the threshold distance. The dragging indicia can also be used as graphical feedback to inform a user as to which radial direction the interactive element is being dragged. In some embodiments, however, a dragging indicia is not displayed to the user.

A graphical display can display a plurality of interactive elements, with each interactive element associated with a particular application. FIG. 9 depicts an example interactive element menu 900 displaying an interactive element A, an interactive element B, and an interactive element C in accordance with one aspect of the present disclosure. A user can gesturally interact with each interactive element A-C to initiate various actions. Interactive element A is associated with a subsystem which is can be in an “ON” or “OFF” position. As represented by box 908, when the interactive element A is dragged such that a threshold distance is exceeded, the subsystem is toggled to switch its operational state. Interactive element B is associated with a pre-defined action. As shown by box 910, when the interactive element B is dragged such that a threshold distance is exceeded, the pre-defined action is initiated. Interactive element C is associated with a two pre-defined actions. As shown by box 912, when the interactive element C is dragged in a first direction such that a threshold distance is exceeded, the first pre-defined action is initiated. As shown by box 914, when the interactive element C is dragged in a second direction such that a threshold distance is exceeded, the second pre-defined action is initiated.

It is noted that activation of an interactive element can initiate the display of additional interactive elements. FIG. 10 depicts an example interactive element menu 1000 that displays an interactive element A in accordance with one aspect of the present disclosure. As shown by box 1004, when the interactive element A is dragged in a first direction such that a threshold distance is exceeded, an interactive element B is displayed. As shown by box 1006, when the interactive element A is dragged in a second direction such that a threshold distance is exceeded, an interactive element C can be displayed.

FIG. 11 depicts an example block diagram of a gesture-based control system. A user can execute a gesture in a gesturing field 1102, which can be in the viewing area of a camera 1104 in accordance with one aspect of the present disclosure. As provided above, the gesture can be in relation to an interactive element (not shown) presented on a graphical display 1100. The camera 1104 can detect and capture location, orientation, and movement of the gesture which generates output signals to gesture processor 1106. The gesture processor 1106 can translate the information and data received from the camera 1104 into a gesture signal that is provided to the controller 1108 of the system. In an alternate embodiment, the gesture processor 1106 and controller 1108 can be combined into a single device. The controller 1108 can be in communication with, or otherwise control subsystems 1110, shown as subsystems A, B . . . N, and can provide display output to the graphical display 1100. The controller 1108 can use the input information from the gesture processor 1106 to generate a command signal to control one or more subsystems 1101 as well as provide information to the graphical display 1100.

More cameras (e.g., two cameras, six cameras, eight cameras, etc.) or a single camera can be utilized without departing from the scope or spirit of the embodiment. In fact, any number or positioning of cameras that detects or captures the location, orientation, and movement of the user can be used. In other embodiments, however, other types of gesture sensors can be used.

In some embodiments, the gesture-based control system of FIG. 11 can be integrated with vehicle, with the subsystems 1110 including vehicle subsystems, such as navigational systems, entertainment systems, climate systems, and other peripheral systems, for example. Accordingly, the gesture-based control system described herein can integrate with one or more vehicular subsystems including, but not limited to, interactive navigation devices, radio and digital audio players, telephones, cruise control, automated guidance modules, climate control, operational information visualizations, networked applications, and so forth, which may be referred to herein as applications.

FIGS. 12A-12B depict a simplified version of an example vehicle graphical display 1200 which can be mounted in a portion of a vehicle 1202 in accordance with one aspect of the present disclosure, with FIG. 12B illustrating an enlarged portion of FIG. 12A. The graphical display 1200 can be, for example, a component of an infotainment system and mounted to a dashboard 1204 of the vehicle 1202. In other embodiments, the graphical display 1200 could be a component of an instrument cluster 1206, or even positioned elsewhere in the vehicle compartment. Through gesture-based interactions, an occupant of the vehicle 1202 can control various subsystems of the vehicle.

In the illustrated embodiment, the graphical display 1200 is configured to display three interactive elements, namely an entertainment interactive element 1204A, a navigation interactive element 1204B, and a climate center interactive element 1204C. A threshold indicia is graphically presented for each interactive element. A threshold indicia 1210A shows the threshold distance associated with the entertainment interactive element 1204A, a threshold indicia 1210B shows the threshold distance associated with the navigation interactive element 1204B, and a threshold indicia 1210C shows the threshold distance associated with the climate center interactive element 1204C. While each threshold indicia 1210A, 1210B and 1210C are illustrated as being the same size, in other embodiments, the particular size or shape of the threshold indicia can vary from interactive element to interactive element. Further, these threshold indicia may be constantly presented, or presented upon selection of the associated interactive element. To activate one of the interactive elements 1204A, 1204B and 1204C, a user can select one of the interactive elements through a remote selection gesture and then drag the selected interactive element past the associated threshold indicia (1210A, 1210B, 1210C). The resulting activation of each interactive elements 1204A, 1204B and 1204C is described in more detail below.

Referring first to entertainment interactive element 1204A on the graphical display 1200, a user can drag the entertainment interactive element 1204A in any direction past the threshold indicia 1210A to activate an associated application. In certain embodiments, the associated application is a vehicle entertainment system. When the entertainment interactive element 1204A is activated, for example, a music player or other entertainment system can be activated and an entertainment graphical display 1200A can be presented to the user. As is to be readily appreciated, the particular functions presented to the user can vary based on the type of entertainment system. As such, when a user is watching a DVD or BLUE RAY™, for example, the particular functions presented on the graphical display can differ from the functions displayed when the user is listening to a music player. The entertainment graphical display 1200A can include the entertainment interactive element 1204A to give the user direction-based gesture-based control of entertainment functions. In the illustrated embodiment, the entertainment functions include “volume up” 1252A, “track down” 1252B, “volume down” 1252C, and “track up” 1252D. Accordingly, when the entertainment interactive element 1204A of the entertainment graphical display 1200A is selected and dragged past a threshold indicia 1250A, an audio volume is increased. When the entertainment interactive element 1204A of the entertainment graphical display 1200A is selected and dragged past a threshold indicia 1250B, the track of the current musical selection is decreased. When the entertainment interactive element 1204A of the entertainment graphical display 1200A is selected and dragged past a threshold indicia 1250C, an audio volume is decreased. When the entertainment interactive element 1204A of the entertainment graphical display 1200A is selected and dragged past a threshold indicia 1250D, the track of the current musical selection is increased. As illustrated, the threshold indicia 1250B and 1252D are positioned relatively closer to the interactive element 1204A than the threshold indicia 1250A and 1252C. Accordingly, in the illustrated embodiment, a user interacting with graphical display 1200A the has to move the interactive element 1204A further to initiate a volume change than the movement of the interactive element 1204A necessary to initiate a track change.

Referring next to navigation interactive element 1204B on the graphical display 1200, a user can drag the navigation interactive element 1204B in any direction past the threshold indicia 1210B to activate an associated application. In certain embodiments, the associated application is a navigation system. When the navigation interactive element 1204B is activated, a navigation graphical display 1200B can be presented to the user. The navigation graphical display 1200B can include a map 1260 and a map interactive element 1274 and a destination interactive element 1284. The user can select the map interactive element 1274 and drag it in a particular direction to control the display of the map 1260. For example, though remote drag gestures in various directions, the user can perform functions such as “zoom in” 1276A, “pan left” 1276B, “zoom out” 1276C, and “pan right” 1276D. The user can also select the destination interactive element 1284 and drag it in a particular direction to control destination-based functions. For example, though remote drag gestures in various directions, the user can perform functions such as select a “new destination” 1286A, select “recent destinations” 1286B, or “go home” 1286C.

Referring next to climate center interactive element 1204C on the graphical display 1200, a user can drag the climate center interactive element 1204C in a particular direction past the threshold indicia 1210C to take direction-based actions associated with the climate control. For example, dragging the climate center interactive element 1204C upward will execute a “temp up” 1212A action. Dragging the climate center interactive element 1204C to the left will execute a “fan up” 1212B action. Dragging the climate center interactive element 1204C downward will execute a “temp down” 1212C action. Dragging the climate center interactive element 1204C to the lower right will toggle the A/C 1212D between an “on” and “off” state. Dragging the climate center interactive element 1204C to the right will execute a “fan down” 1212E action. Dragging the climate center interactive element 1204C to the upper right can toggle a “rear defrost” 1212E between an “on” and “off” state.

In some embodiments, the interactive element presented on the graphical display can be customized by a user. By way of example, the graphical display 1200 can display one or more customized interactive elements. When activated defined by a user, the customized interactive element can perform a user-defined action. Thus, a user can create an interactive element that is configured to perform functions that the user routinely performs. In one example embodiment, dragging the interactive element upward can cause a social-based networking application to be displayed on a graphical display. Dragging the interactive element to the right can cause vehicle operational information to be displayed and dragging the interactive element downward can launch a navigational system.

FIG. 13 depicts an example process flow 1300 utilizing a gesture-based control system as described herein in accordance with one aspect of the present disclosure. At 1302, an interactive element is caused to be displayed a graphical display. The interactive element can be associated with at least one application. At 1304, a remote selection gesture of the interactive element is recognized. The remote selection gesture can be, for example, a particular movement performed by a user in a gesturing field. At 1306, a remote drag gesture is recognized. The remote drag gesture can be a translation of a part of user's body from a first position to a second position. At 1308, responsive to recognizing the remote drag gesture, a dragging indicia can be caused to be displayed on the graphical display. In some embodiments, however, a dragging indicia is not displayed on the graphical display. At 1310, it is determined if a drag length exceeds the threshold distance. If the interactive element has not been dragged past the threshold distance, the process returns to 1308 to continue to render the dragging indicia. If, however, the drag length does exceed the threshold distance, at 1312, at least one application associated with the interactive element is caused to be controlled.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semipermanent, and/or semitemporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the disclosure to be defined by the claims appended hereto.

What is claimed is:

1. A computer-implemented method, comprising:
displaying an interactive element on a graphical display, wherein the interactive element is associated with at least one application;
recognizing a remote selection gesture of the interactive element;
recognizing a remote drag gesture;
responsive to recognizing the remote drag gesture, displaying a dragging indicia on the graphical display, wherein the dragging indicia has a drag length that corresponds to the remote drag gesture; and
when the drag length exceeds a threshold distance, controlling the at least one application associated with the interactive element.

2. The computer-implemented method of claim 1, comprising:
responsive to recognizing the remote selection gesture, visually indicating on the graphical display a selection of the interactive element.

3. The computer-implemented method of claim 1, wherein the dragging indicia is a graphical translation of the interactive element on the graphical display.

4. The computer-implemented method of claim 1, wherein the dragging indicia is a graphical translation of a duplicate interactive element on the graphical display.

5. The computer-implemented method of claim 1, comprising:
displaying a threshold indicia on the graphical display, wherein a distance between the interactive element and the threshold indicia is the threshold distance.

6. The computer-implemented method of claim 5, wherein the threshold indicia is caused to be displayed subsequent to recognizing the remote selection gesture.

7. The computer-implemented method of claim 6, comprising:
subsequent to causing the at least one application associated with the interactive element to be controlled, removing the threshold indicia from the graphical display.

8. The computer-implemented method of claim 5, wherein the threshold indicia is radially spaced from and at least partially surrounds the interactive element on the graphical display.

9. The computer-implemented method of claim 8, wherein the threshold indicia is circular.

10. The computer-implemented method of claim 1, wherein the dragging indicia has a radial drag direction that corresponds to the remote drag gesture.

11. The computer-implemented method of claim 10, comprising:
performing an action by the at least one application associated with the interactive element, wherein the action performed is based on the radial drag direction.

12. The computer-implemented method of claim 11, comprising:
performing a first action by the at least one application associated with the interactive element when the radial drag direction is a first radial drag direction; and
performing a second action by the at least one application associated with the interactive element when the radial drag direction is a second radial drag direction.

13. The computer-implemented method of claim 10, comprising:
when the drag length exceeds a first threshold distance and the drag direction is in a first direction, controlling a first application associated with the interactive element; and
when the drag length exceeds a second threshold distance and the drag direction is in a second direction, controlling a second application associated with the interactive element, wherein the first application is different from the second application.

14. The computer-implemented method of claim 13, wherein the first threshold distance is the same as the second threshold distance.

15. The computer-implemented method of claim 1, wherein the application is a vehicle subsystem.

16. The computer-implemented method of claim 15, wherein the vehicle subsystem is one of an entertainment system, a climate system, and a navigation system.

17. A gesture-based control system, comprising:
a graphical display;
a camera; and
a controller in communication with the graphical display and the camera, the controller configured to:
display an interactive element on the graphical display, wherein the interactive element is associated with at least one application;
recognize a remote selection gesture of the interactive element;
recognize a remote drag gesture;
responsive to recognizing the remote drag gesture, determine a drag length of the selected interactive element; and
when the drag length exceeds a threshold distance, control the at least one application.

18. The gesture-based control system of claim 17, wherein the controller is configured to:
responsive to recognizing the remote drag gesture, display a dragging indicia on the graphical display, wherein the dragging indicia substantially corresponds to the remote drag gesture.

19. The gesture-based control system of claim 17, wherein the controller is configured to:
display a threshold indicia on the graphical display, wherein a distance between the interactive element and the threshold indicia is the threshold distance.

20. The gesture-based control system of claim 19, wherein the controller is configured to:
display the threshold indicia subsequent to recognizing the remote selection gesture.

21. The gesture-based control system of claim 17, wherein the dragging indicia has a radial drag direction that substantially corresponds to the remote drag gesture.

22. The gesture-based control system of claim 19, wherein the controller is configured to facilitate:
performing an action by the at least one application associated with the interactive element, wherein the action performed is based on the radial drag direction.

23. The gesture-based control system of claim 19, wherein the controller is configured to facilitate:
performing a first action by the at least one application associated with the interactive element when the radial drag direction is a first radial drag direction; and
performing a second action by the at least one application associated with the interactive element when the radial drag direction is a second radial drag direction.

24. The gesture-based control system of claim 19, wherein the application is a vehicle subsystem.

25. The gesture-based control system of claim 24, wherein the vehicle subsystem is one of an entertainment system, a climate system, and a navigation system.

26. A computer-implemented method, comprising:
displaying an interactive element on a graphical display of a vehicle, wherein the interactive element is associated with a vehicle subsystem;
recognizing a remote drag gesture associated with the interactive element;
responsive to recognizing the remote drag gesture, displaying a dragging indicia on the graphical display, wherein the dragging indicia has a drag length that corresponds to the remote drag gesture; and
when the drag length exceeds a threshold distance, controlling the vehicle subsystem.

27. A computer-implemented method of claim 26, comprising:
recognizing a remote selection gesture of the interactive element.

28. A computer-implemented method of claim 26, wherein the dragging indicia has a radial drag direction that substantially corresponds to the remote drag gesture.

29. A computer-implemented method of claim 26, comprising:
performing an action by the vehicle subsystem, wherein the action performed is based on the radial drag direction.
